(19) United States
(12) Patent Application Publication
(10) Pub. No.: US 2010/0064251 A1
(43) Pub. Date: Mar. 11, 2010

(54) TOGGLING WINDOW DISPLAY STATE BY SCREEN IN A MULTI-SCREENED DESKTOP ENVIRONMENT

(75) Inventors: Mark R. Hufnagel, Morrisville, NC (US); Tyler S. Lacock, Morrisville, NC (US); Aaron K. Shook, Raleigh, NC (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/205,536

(22) Filed: Sep. 5, 2008

(51) Int. Cl. G06F 3/048

(52) U.S. Cl. 715/788

(57) ABSTRACT

An event to toggle a screen state of a screen of a desktop environment can be detected. The desktop environment can include a set of screens. Screen states of the screens can include a minimized screen state and a restored screen state. The minimized screen state can be a state in which all windows associated with the screen have a minimized window state. The restored screen state can be a state in which at least one window associated with the screen has an open display state. An open display state can include a maximized window display state or an adjusted window display state. The screen state of the screen of the desktop environment can be toggled responsive to the detected event without affecting a screen state of other ones of the set of screens.

### BACKGROUND

The present invention relates to the field of user interfaces, more particularly, to toggling window display state by screen in a multi-screened desktop environment.

When working with a desktop environment on a computing device, client windows are arranged in a desktop environment allowing the user to interact with each client window separately. Typically, desktop environments implement different display states of each client window. The most common display states of client windows are maximized, minimized, and adjustable. A maximized display state of a client window can be when the dimensions of the window have been altered to span the length and width of the entire display screen. A minimized display state can be when the client window is no longer displayed in the display screen and only a visual control is left to alter the display state of the client window. An adjustable display state can be when the client window occupies less than the screen size, where it can be positioned and sized within the screen based upon user input (i.e., grabbing a corner of a window to size it or moving an adjustable window to a desired position using a mouse). When a minimized window is activated, it is typically returned to its previous state, which can be either a maximized or an adjusted state. A maximized window can be shifted to an adjusted state, which uses any previously established settings for the adjusted state with regard to window position and size.

Managing the client windows in a desktop environment can become troublesome when many client windows are present at the same time. When many client windows are present in the desktop environment, it can be easy to run out of available space to place windows in the environment. Current technology presents some solutions to this problem. Some desktop environments implement virtual desktops, or separate discreet display screens in which can each include a separate set of client windows. These virtual desktops can be displayed on a single display device and can be switched between by using a visual control, hotkey, or the like. Another solution is to expand the available desktop environment space by connecting more than one physical display devices and expanding the desktop across all connected display devices; the expanded desktop can be treated as a single display screen or as multiple display screens - one per display device.

In most desktop environments, a user can store documents on their desktop. These documents can be displayed as icons associated with the content of the document. There are cases when too many client windows fill the desktop environment and a user may need to return to their desktop quickly. For example, a user may need to access a file in which is stored on their desktop, or a newly created application window was created on the desktop rather than in front of the other application windows. Currently, a solution exists in some desktop environments (e.g., a show desktop option) to alter the display state of all the application windows in the desktop environment. When selected, all active windows on the desktop are shifted to a minimized state. Another option, (e.g., a show open windows option) can then be selected to restore the desktop. Selection of this option results returning windows minimized responsive to the show desktop option to their previous display state. This solution works, but applies to every client window in the desktop environment. This solution lacks control to selectively alter the display state of the application windows according to the display screen in which they are located.

### BRIEF DESCRIPTION OF THE SEVERAL VIEWS OF THE DRAWINGS

FIG. 1 is a schematic diagram of a system for toggling the display state of client windows in a discreet display screen or screens in accordance with an embodiment of the inventive arrangements disclosed herein.

FIG. 2 illustrates interfaces for toggling the display state of client windows in a discreet display screen or screens in accordance with an embodiment of the inventive arrangements disclosed herein.

FIG. 3 is a flow chart of a method for toggling the display state of client windows in a discreet display screen or screens in accordance with an embodiment of the inventive arrangements disclosed herein.

### DETAILED DESCRIPTION

The present invention can enable toggling the display state of client windows in accordance with the discreet display screen in which they are located. The present invention can include an enhancement for existing desktop environment software to include GUI (graphical user interface) controls to toggle the display state of all of the client windows contained in a display screen. When this GUI control is triggered, the present invention can determine which display screen or screens' display state to toggle. Once the display screen or screens have been determined, the present invention can determine which client windows are located in the determined display screen or screens. Once these client windows have been determined, the display state of these client windows can be altered to match the changed display state of the display screen. The display state of the display screen can include screen states of restored or minimized. When the screen state is minimized, all windows associated with that screen are placed in a minimized state. When the screen state is restored, windows associated with the screen are placed in their default state, which is a state specific to that window before an option to adjust a screen to a minimized state occurred. Windows within a restored screen can be in a minimized display state, a maximized display state, or an adjustable display state.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, for instance, via optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

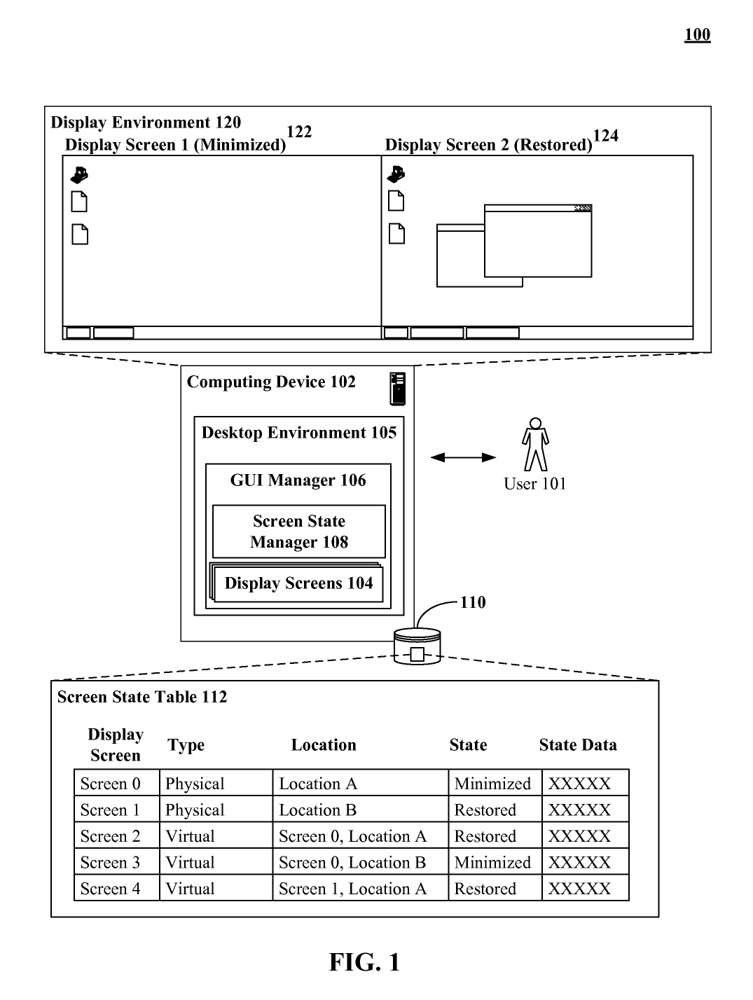

FIG. 1 is a schematic diagram of a system 100 for toggling the display state of client windows in a discreet display screen or screens in accordance with an embodiment of the inventive arrangements disclosed herein. System 100 can include computing device 102, which can include a desktop environment 120 displayed using a set of display screens 122, 124. In one embodiment, user interface interactions can be handled by a Graphical User Interface (GUI) manager 106 of an operating system 105. A screen state manager 108 can handle specific adjustments relating to screen states of the display screens 104, such as screen 122 and 124. Screen 104 states can include a minimized (e.g., screen 122) and a restored state (e.g., screen 124). When a display screen 104 is in a minimized state, as shown by screen 122, all open windows associated with that screen can be minimized, as depicted by screen 122. When a display screen 104 is in a restored state 124, windows associated with the display screen can be in a window specific display state, which includes a minimized state, a maximized state, and an adjustable state. Minimizing a screen and then restoring the screen causes all associated windows to be restored to a display state existent before the screen was adjusted to a minimized state.

In other words, desktop environment 120 can be enhanced to allow toggling the display state of client windows in each display screen 104. User 101 can interact with the desktop environment 120 through one or more interface controls, which permit the user 101 to change or toggle a screen state between a minimized state and a restored state. The controls can permit any number of screens from one to N, where N is the total number of screens of environment 120 to have their states adjusted. The GUI manager 106 can be a software component responsible for the management of client windows in the desktop environment 120 and their properties. Screen state manager 108 can be a software component enhancement for GUI manager 106 which can allow for the toggling of a display screen's display state. In one embodiment, screen state manager 108 can utilize data stored on data store 110 to manage the screen states of display screens 104, which can be illustrated by screen state table 112.

Display screens 104 can be physical or virtual display areas for computing device 102. In some embodiments, computing device 102 can have a single physical display device, but a plurality of virtual display screens for the single physical display device. These virtual display screens can be a sectioned off area of the desktop environment. In some embodiments, the virtual display screens can be an alternate view of the desktop environment. Each screen can be a “page” in which client windows can take up space. For example, a user can use one virtual display screen and open a plurality of client windows, then switch to another virtual display screen in which no client windows have been opened. The client windows remain open in the previous virtual display screen and will appear on the desktop environment when the user returns to that virtual display screen.

Display screens 104 can also be a screens associated with a set of different physical display devices. A one-to-one correspondence between screens and display devices can exist, but this is not a limitation of the disclosure. For example, a single screen 104 can span a set of two or more physical devices. Additionally, a physical display device can be associated with multiple screens, as is the case with a virtual display screens. In one embodiment, display screens 104 can be a combination of both physical and virtual display screens.

Desktop environment 120 can provide a graphical interface desktop environment for user 101. A desktop environment 120 can be provided by an operating system 105, or an application run by an operating system 105. A desktop environment 210 can provide a user 101 with a graphical interface to interact with their computers' functions such as file management, application management and interaction, connectivity, and the like. Desktop environment 120 can be designed create a desktop metaphor. A desktop metaphor can be created in the sense that the created desktop environment is the user's physical desktop and open documents can be paper copies of documents on their desktop. The programmatic instruction code necessary to provide a desktop environment 120 can be included in the OS 105, the GUI manager 106, and/or other software/firmware. Desktop environment 120 can be implemented in many ways. For example, desktop environment 120 can include, but is not limited to, MICROSOFT WINDOWS, MAC OS, an X windows server (i.e. XFREE86, X386, X.ORG) working in accordance with a window manager (i.e. GNOME, KDE, CDE), and the like.

GUI manager 106 can be a software component that controls the placement and appearance of client windows. Client windows can be views created for running applications in desktop environment 120. When a user triggers a GUI control, a message can be conveyed to GUI manager 106. GUI manager 106 can parse and react to the message received. For example, GUI manager 106 can receive a message that a user has activated a GUI option to change the display state of a client window to minimized, restored, or maximized. GUI manager 106 can respond by toggling the display state of the window and/or screen to the desired state. GUI manager 106 can implement screen state manager 108 to enable the toggling of the display state of display screens 104.

Screen state manager 108 can manage and allow the modification of the display states of display screens 104. Screen state manager 108 can be used to respond to messages received by GUI manager 106 in which indicate the user wishes to alter the display state of a display screen. Screen state manager 108 can use data stored on data store 110 to manage the states of display screens 104.

Screen state table 112 can illustrate data stored on data store 110 for screen state manager 108. As illustrated, screen state table 112 can include fields display screen, type, location, state, and state data. The display screen field can be used to hold a unique ID for the display screen. The type field can be used to hold the type of display screen, whether it is a physical device or if it is a virtual desktop environment division. The location field can be used to store the location and orientation of the display screen. For example, the location field can store whether one screen is to the left or right of another, or if one is a little higher or lower than another is. The location field can also include the location of virtual display screens in relationship to other display screens. The state field can be used to the current state of the display screen. The state data field can be used to store additional data required to toggle the display state of the display screen. For example, previous state data can be stored to accurately toggle the display state of the display screen later.

Computing device 102 can be any computing device that can include a plurality of display screens 104, and can run desktop environment 120, which can be enhanced to enable the toggling the display state of client windows in accordance with the discreet display screen in which they are located. Computing device 102 can be any computing device including, but not limited to, a desktop computer, a server computer, a laptop, a cell phone, a personal data assistant (PDA), and the like.

Data store 110 can be physically implemented within any type of hardware including, but not limited to, a magnetic disk, an optical disk, a semiconductor memory, a digitally encoded plastic memory, a holographic memory, or any other recording medium. The data store 110 can be a stand-alone storage unit as well as a storage unit formed from a plurality of physical devices, which may be remotely located from one another. Additionally, information can be stored within each data store in a variety of manners. For example, information can be stored within a database structure or can be stored within one or more files of a file storage system, where each file may or may not be indexed for information searching purposes.

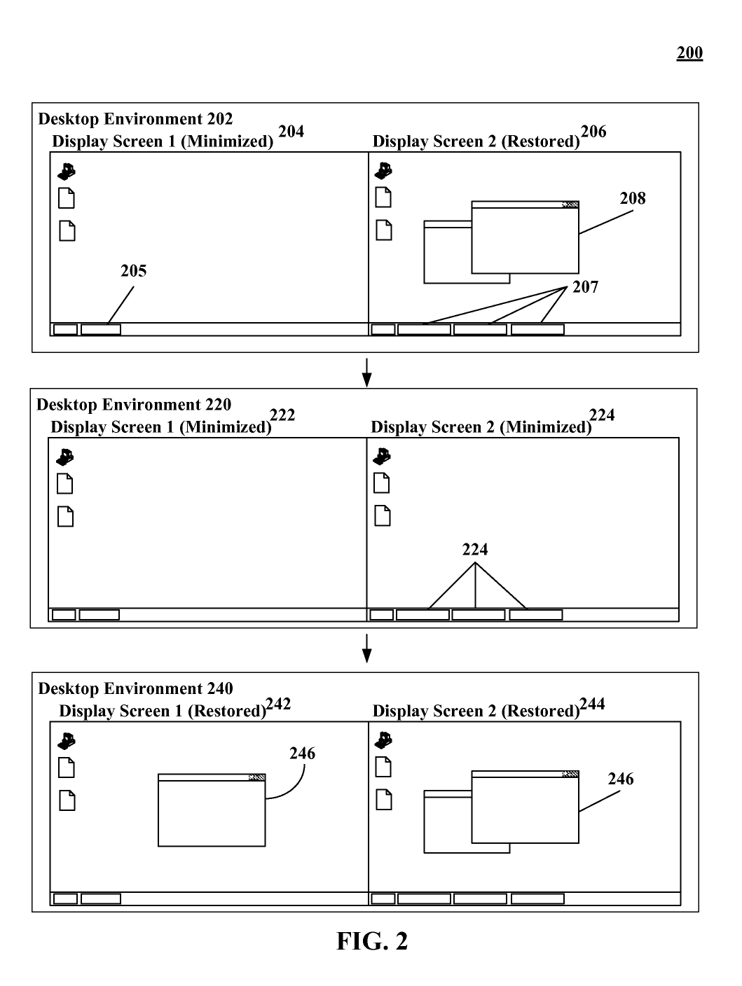

FIG. 2 illustrates interfaces for toggling the display state of client windows in a discreet display screen or screens in accordance with an embodiment of the inventive arrangements disclosed herein. FIG. 2 can include multiple desktop environment interfaces which illustrate different display states of each display screen illustrated. Each desktop environment interface 202, 220, and 240 can be in context of desktop environment 105 of system 100. Desktop environment 202 can include display screen 204 and display screen 206. Display screen 204 can be in the minimized state. Control 205 can be a visual control in which the display state of the client window can change to restored. Control 205 can also act a visual indicator that the client window is still accessible, or running. Display screen 206 can be in the restored state. Client window 208 can be visible on the desktop. Controls 207 can be visual indicators of the running client windows. Not all of the running client windows have to be on the desktop in the restored state.

Desktop environment 220 can illustrate desktop environment 202 after a user toggles the display state of display screen 206. Desktop environment 220 can include display screen 222, which can be an illustration of display screen 204 after the toggling of the display state. Because the display state of display screen 204 was not toggled, display screen 204 remains the same as display screen 222. Display screen 224 can illustrate display screen 206 after the toggling of the display state. No client windows are being shown on the display screen anymore, including client window 208. Visual indicators 207 can remain unchanging as visual indicators 224. In some embodiments, the visual indicators 207 can change into an alternate visual indication to show the client window display state has changed.

Desktop environment 240 can illustrate desktop environment 220 after a user toggles the display state of both display screens 222 and 224. Display screen 242 can illustrate display screen 222 and display screen 244 can illustrate display screen 224. Because both display screens 222 and 224 were in the minimized display state, both display screens can be toggled to the restored stated in desktop environment 240. Display screen 242 can include client window 246, which can be the client window indicated by visual indicator 205. Display screen 244 can have restored the windows that were previously in the restored state, as shown by display screen 206.

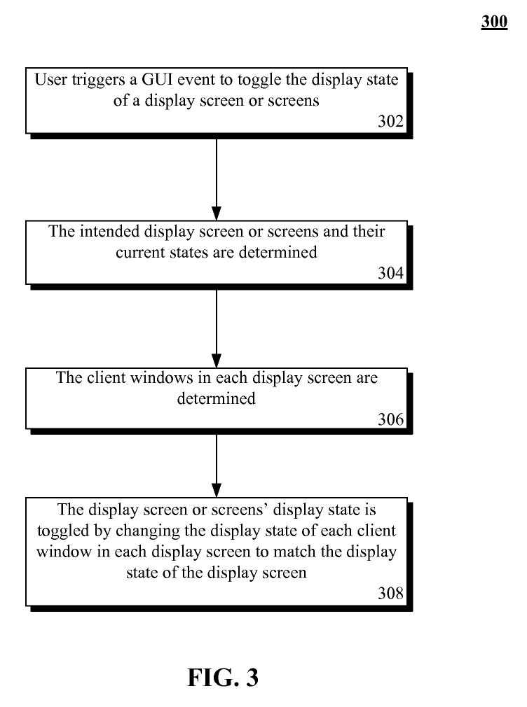

FIG. 3 is a flow chart of a method 300 for toggling the display state of client windows in a discreet display screen or screens in accordance with an embodiment of the inventive arrangements disclosed herein. Method 300 can be performed in context of system 100. Method 300 can begin in step 302 where a user can trigger a graphical user interface (GUI) event to toggle the display state of a display screen or screens. In step 304, the intended display screen or screens and their current states can be determined. In step 306, the client windows located in each display screen can be determined. In step 308, the display screen or screens' display state can be toggled by changing the display state of each client window in each display screen to match the display state of the display screen.

The flowchart and block diagrams in the FIGS. 1-3 illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for controlling multiple displays from a computing device comprising:
detecting an event to toggle a screen state of a screen of a desktop environment comprising a plurality of screens, wherein screen states of the screen comprise a minimized screen state and a restored screen state, wherein the minimized screen state is a state in which all windows associated with the screen have a minimized window state, wherein the restored screen state is a state in which at least one window associated with the screen has an open display state, wherein an open display state comprises at least one of a maximized window display state and an adjusted window display state; and
toggling the screen state of the screen of the desktop environment responsive to the detected event without affecting a screen state of other ones of the plurality of screens.

2. The method of claim 1, wherein the plurality of screens are virtual desktop screens.

3. The method of claim 1, wherein the plurality of screens are each associated with a different physical display devices.

4. The method of claim 1, further comprising:
toggling the screen state of the screen to a minimized screen state.

5. The method of claim 4, said toggling of the screen state to the minimized screen state further comprising:
detecting a display state of at least one open window associated with the screen; and
toggling the display state of each of the at least one open window associated with the screen to a minimized state.

6. The method of claim 1, further comprising:
toggling the screen state of the screen to a restored screen state.

7. The method of claim 6, said toggling of the screen state to the restored screen state further comprising:
determining at least one window associated with the screen;
ascertaining a previous display state of each determined window associated with the screen, wherein the previous display states represent a display state of each window before the screen was placed in a screen minimize state; and
changing a display state of each determined window to the previous display state.

8. The method of claim 1, further comprising:
saving a screen state of said desired screen before altering the screen state to a minimized state, wherein the saved screen state is used to restore the screen state to its previous state when the screen state is toggled back to a restored state.

9. A computer program product for controlling multiple displays from a computing device comprising: a computer usable medium having computer usable program code embodied therewith, the computer usable program code comprising:
computer usable program code configured to detect an event to toggle a screen state of a screen of a desktop environment comprising a plurality of screens, wherein screen states of the screen comprise a minimized screen state and a restored screen state, wherein the minimized screen state is a state in which all windows associated with the screen have a minimized window state, wherein the restored screen state is a state in which at least one window associated with the screen has an open display state, wherein an open display state comprises at least one of a maximized window display state and an adjusted window display state; and
computer usable program code configured to toggle the screen state of the screen of the desktop environment responsive to the detected event without affecting a screen state of other ones of the plurality of screens.

10. The computer program product of claim 9, wherein the plurality of screens are virtual desktop screens.

11. The computer program product of claim 9, wherein the plurality of screens are each associated with a different physical display devices.

12. The computer program product of claim 9, further comprising:
computer usable program code configured to toggle the screen state of the screen to a minimized screen state.

13. The computer program product of claim 12, said computer usable program code configured to toggle of the screen state to the minimized screen state further comprising:
computer usable program code configured to detect a display state of at least one open window associated with the screen; and
computer usable program code configured to toggle the display state of each of the at least one open window associated with the screen to a minimized state.

14. The computer program product of claim 9, further comprising:
computer usable program code configured to toggle the screen state of the screen to a restored screen state.

15. The computer program product of claim 14, said computer usable program code configured toggle of the screen state to the restored screen state further comprising:
computer usable program code configured to determine at least one window associated with the screen;
computer usable program code configured to ascertain a previous display state of each determined window associated with the screen, wherein the previous display states represent a display state of each window before the screen was placed in a screen minimize state; and
computer usable program code configured to change a display state of each determined window to the previous display state.

16. The computer program product of claim 9, further comprising:
computer usable program code configured to save a screen state of said desired screen before altering the screen state to a minimized state, wherein the saved screen state is used to restore the screen state to its previous state when the screen state is toggled back to a restored state.

17. A graphical user interface comprising:
a plurality of screens, each screen having a current screen state, wherein a current screen state comprises one of a minimized screen state and a restored screen state, wherein the minimized screen state is a state in which all windows associated with the screen have a minimized window state, wherein the restored screen state is a state in which at least one window associated with the screen has an open display state, wherein an open display state comprises at least one of a maximized window display state and an adjusted window display state; and
a screen state toggle control configured to be selected by a user to selectively toggle a screen state of one of the plurality of screens of a desktop environment without affecting a screen state of other ones of the plurality of screens.

18. The graphical user interface of claim 17, wherein each of the plurality of screens are virtual desktop screens.

19. The method of claim 1, wherein the plurality of screens are each associated with a different physical display devices.
